(19) United States
(12) Patent Application Publication
(10) Pub. No.: US 2019/0036391 A1
(43) Pub. Date: Jan. 31, 2019

(54) STATOR FOR AN ELECTRIC MOTOR, METHOD FOR THE PRODUCTION THEREOF, AND ELECTRIC MOTOR

(71) Applicant: BROSE FAHRZEUGTEILE GMBH & CO. KOMMANDITGESELLSCHAFT, WUERZBURG, Wuerzburg (DE)

(72) Inventors: GERHARD BROHM, VEITSHOECHHEIM (DE); MATTHIAS KOCH, WALDBUETTELBRUNN (DE); JASMIN KURBEGOVIC-ZRNIC, WUERZBURG (DE); PETER PSZOLA, BONN (DE); WERNER STEINMETZ, FORCHHEIM (DE); SIMON WAASNER, FORCHHEIM (DE)

(21) Appl. No.: 16/151,532

(22) Filed: Oct. 4, 2018

Related U.S. Application Data
(63) Continuation of application No. PCT/EP2017/057869, filed on Apr. 3, 2017.

(30) Foreign Application Priority Data
Apr. 4, 2016 (DE) 102016205538.0

(51) Int. Cl. H02K 1/16; H02K 1/14; H02K 1/18; H02K 15/02; H02K 3/52

(52) U.S. Cl. CPC H02K 1/165; H02K 1/148; H02K 2203/09; H02K 15/022; H02K 3/522; H02K 1/185

(57) ABSTRACT

A stator for an electric motor contains a cylindrical stator yoke and a stator star which is joined to the cylindrical stator yoke and has a number of radially outwardly directed stator teeth. The tooth tips of the stator teeth bear against corresponding connecting points on the inner circumference of the stator yoke in the joined state. The stator yoke and the stator star are each formed by a punch-stacked laminated core, and in each case an adhesive, which is drawn in via capillaries, for establishing a cohesive connection is introduced between the stator star-side tooth tips and the stator yoke-side connecting points.

### CROSS-REFERENCE TO RELATED APPLICATION

This is a continuation application, under 35 U.S.C. § 120, of copending international application No. PCT/EP2017/057869, filed Apr. 3, 2017, which designated the United States; this application also claims the priority, under 35 U.S.C. § 119, of German patent application No. 10 2016 205 538.0, filed Apr. 4, 2016; the prior applications are herewith incorporated by reference in their entirety.

### BACKGROUND OF THE INVENTION

### Field of the Invention

The invention relates to a stator for an electric motor, in particular for a steering motor of a motor vehicle, containing a cylindrical stator yoke, a stator star joined to the stator yoke and a number of stator teeth which are directed radially outwards and whose tooth tips bear against corresponding connection points on the inner circumference of the stator yoke in the joined state. The invention further relates to a method for producing such a stator.

The stator of an electric motor typically forms the fixed motor part, while a rotor of the electric motor forms the moving motor part. In the case of an internal-rotor motor, the stator is generally provided with a stator yoke on which stator teeth are arranged which protrude radially inwards towards the center and whose free ends, facing the rotor, form the so-called pole shoe. Windings, which generate a magnetic field during electric-motor operation, are applied to the stator teeth.

In order to provide access to the stator teeth from the outside during the production of the stator for winding of the stator teeth with the coils assigned thereto, a multi-part design of the stator comprising stator teeth which are directed radially outwards starting from the pole shoe is conventional, as is known, for example, from published, non-prosecuted German patent applications DE 10 2013 003 024 A1 (corresponding to U.S. patent publication No. 2016/0111929), DE 10 2013 007 730 A1 or DE 10 2012 021 132 A1. For this purpose, in the case of the known stator, first a laminate stack containing star-shaped stator teeth (star-type laminate stack) is produced, with the stator teeth being connected to one another on the pole-shoe side via pole shoe webs in order to achieve a mechanically stable construction. In this case, the stator is manufactured from individual, punched stator laminations by virtue of the stator laminations being stacked to form the star-shaped laminate stack in a mechanically stable construction.

Following the population of the externally accessible stator teeth with the windings (coil windings), preferably by means of so-called coil mounts, the star-type laminate stack provided with the coils or coil mounts pushed onto the stator teeth radially from the outside is inserted into the stator yoke forming a magnetic return path ring and is joined by compression or shrinking. In this case, the stator yoke can likewise be embodied as a laminate stack comprising ring-shaped stator laminations (ring-type laminate stack).

The advantageous, in terms of manufacturing engineering, separation between the star-shaped stator component, referred to below as stator star, and the (cylindrical) stator yoke as further stator component does, however, have the acoustic disadvantage that, in the case of an electric motor equipped with such a stator, the operationally dependent electromagnetic forces excite the entire stator causing oscillations thereof. Owing to the separation between the stator star and the stator yoke, a resonant frequency occurs in a range, in particular at approximately 1350 Hz, which, in the case of the use of such an electric motor, in particular in the case of a steering motor, in a motor vehicle, is transmitted into the interior of the vehicle as structure-borne noise via motor compartment structures, for example from the steering via corresponding structures in the motor compartment, and is perceived there as disruptive air-borne noise.

### SUMMARY OF THE INVENTION

The invention is based on the object of specifying a stator of the type mentioned at the outset which is improved in respect of its acoustic properties, in particular in the case of the use and correct operation of the stator in an electric motor, preferably a steering motor of a motor vehicle. Furthermore, a suitable method for producing such a stator will be specified. In addition, an electric motor, in particular a steering motor for a motor vehicle, containing such a stator will be specified.

As regards the stator according to the invention, the stator has a stator yoke as a cylindrical outer stator component and a stator star as a star-shaped inner stator component containing a number of stator teeth directed radially outwards. The stator teeth serve to receive coils, in particular also in conjunction with coil formers, of a stator winding. The tooth tips, on the free-end side, of the stator teeth bear against corresponding connection points on the inner circumference of the stator yoke when the stator star and the stator yoke are in the joined state. In the joined state, in addition to the force-fitting or frictional compression connection, a cohesive connection is produced between at least some of the tooth tips, preferably between all of the tooth tips, and the respectively corresponding connection point on the inner circumference of the stator yoke. The cohesive connection is in this case implemented by an adhesive drawn in by capillary action.

The stator yoke and the stator star are embodied as punch-stacked laminate stacks. This means that the star-shaped stator component, i.e. the stator star sitting in the stator yoke in the fitted state of the stator, is formed as a laminate stack, for example with alternately closed and at least partially open stator laminations. The stator yoke is formed as a laminate stack containing ring-shaped stator laminations stacked in the axial direction or magnetic return path ring laminations.

By virtue of the adhesive drawn in by capillary action, the manufacturing tolerances of the individual stator laminations which are unavoidable in practice can be used to advantage owing to the fact that, due to the lamination tolerances, lamination gaps are produced at the points of impact of the stator teeth against the yoke-side connection points, with the adhesive material ingressing into the lamination gaps by the capillary effect. As a result, a particularly stable and operationally reliable additional connection between the stator star and the stator yoke is produced.

In this case, the invention is based on the consideration that, firstly, the acoustic properties of such a stator with a separation between the stator star and the stator yoke can be attributed to a resonant frequency of typically less than 1500 Hz which is perceived as structure-borne noise within a vehicle, and that, secondly, an increase in this resonant frequency owing to the frequency-dependent damping in a vehicle of the noise level in the vehicle interior can be reduced. This damping occurs, in a known manner, above a frequency range of from approximately 1500 Hz to 2000 Hz, with the result that an elevation of the resonant frequency by a corresponding magnitude of typically only a few 100 Hz would already result in a marked improvement in the acoustic properties in the vehicle.

As a suitable measure for shifting the resonant frequency of the assembly containing the stator star and the stator yoke into the range of from 1500 Hz to 2000 Hz, a comparatively rigid assembly should be produced. This in turn can take place in a reliable and at the same time simple manner by virtue of additional connection technology for compressing the stator star and the stator yoke, namely by adhesive bonding with capillary action.

The adhesive bonding with capillary action produces, in addition to the force-fitting or frictional connection between the stator star and the stator yoke, a cohesive connection between the stator teeth or the tooth tips thereof and the yoke-side corresponding connection points, with the result that, in comparison with an assembly containing the stator star and the stator yoke with only a force-fitting or frictional connection, a substantially more rigid assembly is produced.

In an advantageous configuration, the tooth tips of the stator teeth are formed with suitably wedge-shaped join contours, and the corresponding connection points on the inner circumference of the stator yoke are formed with mirror-inverted join contours. As a result, firstly a positionally accurate insertion of the stator star and stator yoke one inside the other is achieved. Secondly, these join contours provide a comparatively large and in particular full-surface bearing arrangement of the tooth tips against the corresponding connection points of the stator yoke. The term “bearing arrangement” of the star-side tooth tips against the yoke-side connection points is accordingly also understood to mean insertion of the tooth tips into the corresponding connection points, in particular when the corresponding joints in accordance with the advantageous configuration are shaped in the form of a wedge or the like.

In a suitable development, a two-component bonding agent (2-C bonding agent, for example GP14) is used as the adhesive for the additional cohesive connection of the two components of the stator assembly containing the stator star and the stator yoke. In order to reduce the adhesive viscosity, and therefore to increase the capillary effect during application of the adhesive to the stator, a reactive diluent (for example a styrene, an epoxide or an acrylate) is added or admixed to the adhesive material. In this case, the resin or epoxide proportion of the 2-C bonding agent is preferably, for the large part, replaced by the reactive diluent, with the result that as low a viscosity of the adhesive as possible is ensured during application.

Therefore, the rheological properties of the adhesive are advantageously influenced by the reactive diluent. Owing to the reduction in the viscosity, firstly an improved capillary effect for the introduction of the adhesive into the stator is made possible. Secondly, particularly easy processing and application of the adhesive is ensured, since the wetting of the adhesive on the stator or the laminate stacks is improved.

In the method according to the invention for producing such a stator, first the punch-stacked laminate stacks of the stator yoke and the stator star are provided. In each case one coil of a stator winding is placed onto the outwardly directed stator teeth of the stator star, possibly by means of coil formers, wherein the coil ends of the individual coils are interconnected, for example, by means of an interconnection element of the stator with star or delta contact-making.

In a joining process, the stator star provided with the coils and the stator yoke are joined to one another during a compression process so as to form the connection points between the tooth tips of the stator teeth and the stator yoke. Thereafter, a low-viscosity adhesive, in particular a 2-C bonding agent with added reactive diluent, is applied to the lateral surface of the stator. In other words, the adhesive is applied retrospectively to the lateral surface of the stator, in particular in the joined state of the stator, i.e. substantially in the fitted state of the stator, wherein the adhesive is drawn automatically into the laminate stack of the stator owing to capillary effects.

In this case, the adhesive is applied in particular to the outer circumference of the stator yoke and/or the inner circumference of the stator bore arranged between the pole shoes of the stator star, for example by being brushed or sprayed on. Owing to the low viscosity of the adhesive, in this case firstly advantageous wetting is ensured, as a result of which the application of the adhesive becomes particularly simple. Secondly, the adhesive therefore draws comparatively easily into the intermediate regions formed between the stator laminations, and in particular into the interface of the connection points between the tooth tips of the stator teeth and the stator yoke. As a result, a particularly stable and rigid stator is produced in a simple manner, wherein the produced stator is improved in particular in respect of the acoustic properties in the case of application in a motor vehicle.

In an advantageous configuration, the adhesive is applied in the region of the connection points of the stator yoke. This ensures that an additional cohesive connection between the stator star and the stator yoke is produced.

In a suitable embodiment, the adhesive is introduced into the inner circumference of the stator and is guided at least partially towards the outer circumference by the generation of a centrifugal force. In other words, the adhesive is applied within the stator bore and then guided outwards, in particular towards the connection points between the tooth tips of the stator teeth and the stator yoke, by spinning or rotation of the stator owing to centrifugal and inertial forces. The centrifugal force in this case acts in a supportive way to the capillary forces, as a result of which particularly effective and uniform distribution of the adhesive in the stator laminate stack is made possible. As a result, as large an (inner) surface of the stator laminate stack as possible is covered by the adhesive, which contributes to the overall stability and rigidity of the stator assembly.

In a preferred development, in particular a heat-activatable adhesive is used as the adhesive, wherein the stator is delivered to a heat chamber for curing of the adhesive. This means that the cohesive connection is not formed until during a baking process within the heat chamber. As a result, handling of the stator during production is simplified. Preferably, in the case of a heat-activatable adhesive with added reactive diluents, the reactive diluents become, at least partially, part of the cohesive connection during curing of the adhesive by copolymerization.

In an advantageous development, the adhesive and/or the stator are heated during the deposition process. Owing to the heating, the viscosity of the adhesive is lowered, and therefore the wetting and the flow properties are improved, which has an advantageous effect on the capillary effect. Expediently, the adhesive and/or the stator are heated to a temperature higher than room temperature, wherein the temperature is in particular lower than the curing temperature of the heat-activatable adhesive. In a possible embodiment, the adhesive and the stator are heated, for example, to a temperature range of between approximately 30° C. and 50° C., wherein the curing temperature of the adhesive within the heat chamber is approximately 160° C.

In a preferred development, the stator is heated in particular to a higher temperature than the adhesive. For example, the stator has a temperature which is approximately 5° C. to 10° C. warmer than the adhesive during deposition of the adhesive.

In a preferred application, a stator produced in such a way is used in an electric motor, in particular a steering motor of a motor vehicle. The improved rigidity of the stator assembly in particular in this case has an advantageous effect on the acoustic properties of the electric motor, as a result of which the user comfort in the motor vehicle is increased.

Other features which are considered as characteristic for the invention are set forth in the appended claims.

Although the invention is illustrated and described herein as embodied in a stator for an electric motor and a method for the production thereof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a stator star containing radial stator teeth according to the invention;

FIG. 2 is a perspective view of the stator star, which has been inserted into a cylindrical stator yoke and is frictionally or cohesively connected thereto, without coils and having adhesive applied to the inner and outer lateral surfaces;

FIG. 3 is a perspective view of the stator star shown in FIG. 1 with wound coil formers positioned on the stator teeth; and

FIG. 4 is a detailed, perspective view of an electric motor with an internal rotor and with a stator which rests in the stator yoke in a force-fitting and cohesive manner and is wound with coils.

### DETAILED DESCRIPTION OF THE INVENTION

Mutually corresponding parts and dimensions are always provided with the same reference symbols in all of the figures.

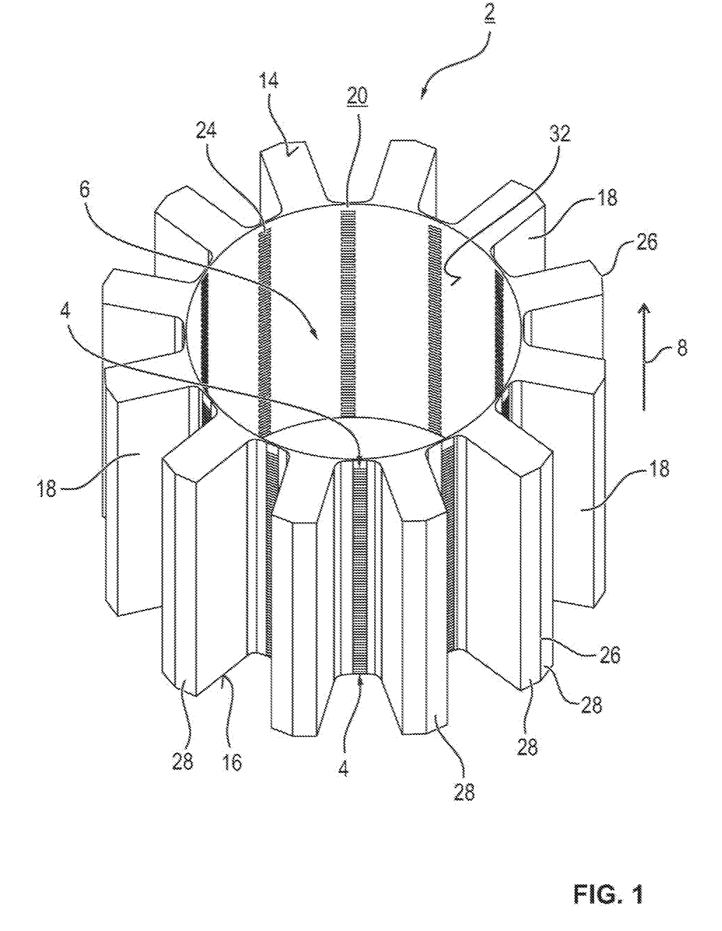

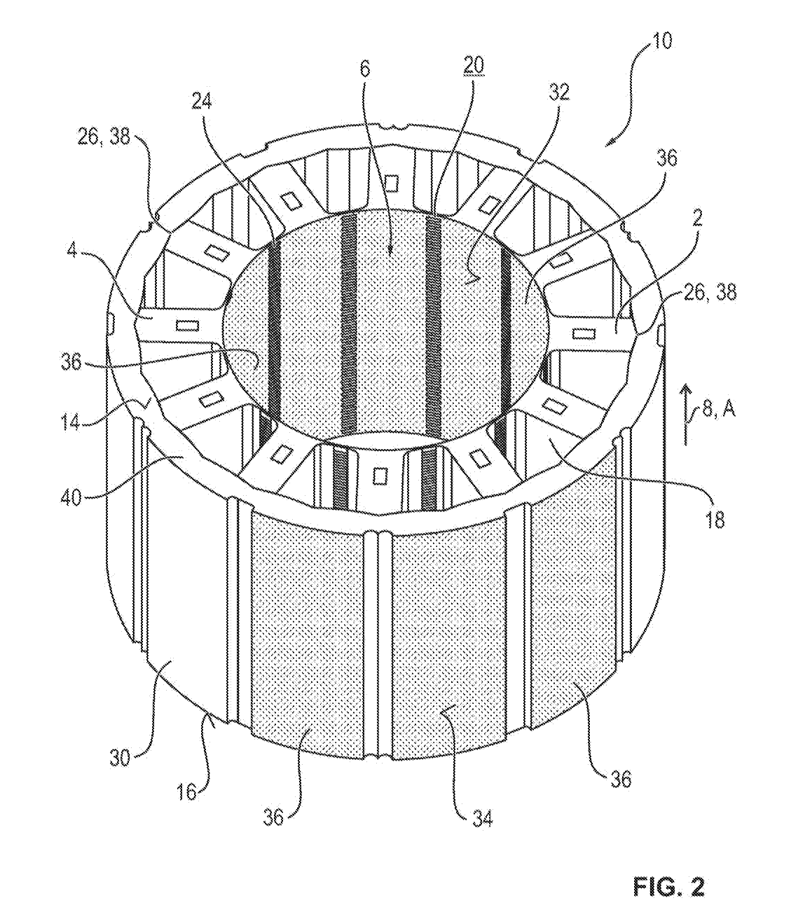

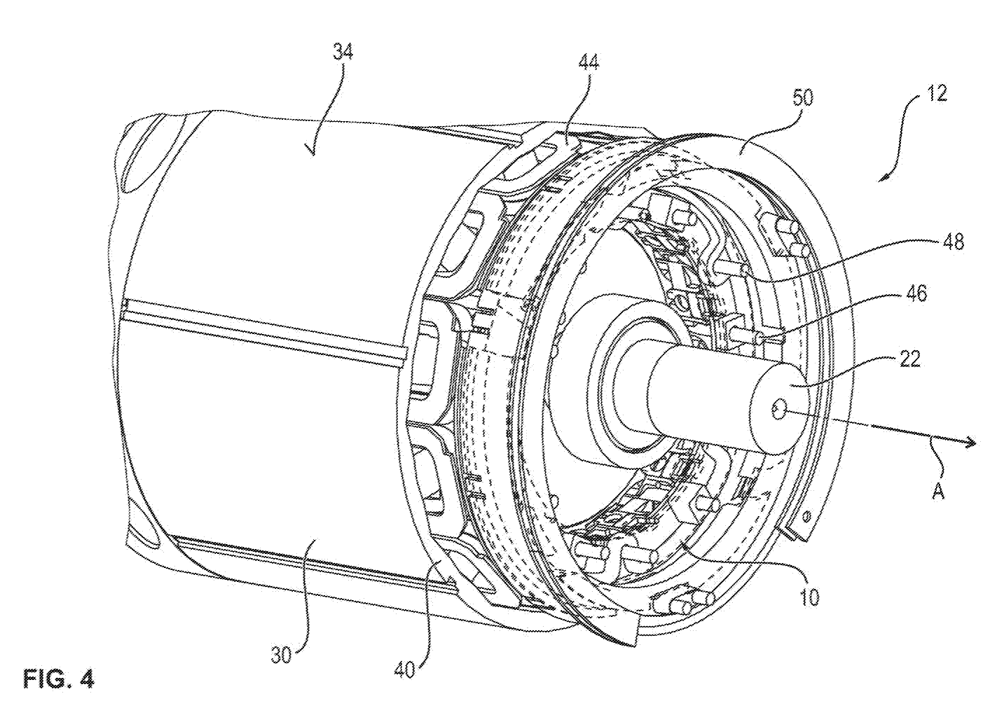

Referring now to the figures of the drawings in detail and first, particularly to FIG. 1 thereof, there is shown a star-shaped stator component, referred to below as a stator star 2, which, in the exemplary embodiment, is produced as a laminate stack containing stator laminations 4 stacked one above the other in layers. The stator laminations 4 are layered one on top of the other and, for example, stamped or punch-stacked with one another in a stacking direction 8 so as to form a central, cylindrical opening 6 as stator bore. The stator star 2 is part of the unwound (shown in FIG. 2) and wound (shown in FIG. 4) stator 10 of an electric motor 12 (illustrated in FIG. 4). The laminate stack of the stator star 2 terminates on an upper side 14 of the stator star and on a lower side 16 of the stator star 2 preferably in each case with at least a one stator lamination 4 closed in the circumferential direction.

The stator star 2 contains stator teeth 18 which extend radially outwards and which form a cylindrical pole shoe 20 on the inner side, which is positioned radially with respect to the center. The stator teeth 18 are provided with reference symbols in the figures, merely by way of example. The pole shoe 20, which faces the rotor 22 (illustrated in FIG. 4) of the electric motor 12, is closed only partially circumferentially in the stacking direction 8 so as to form pole-shoe-side gaps 24, in order to reduce a magnetic short circuit. The stator teeth 18 are provided on the free-end side with wedge-shaped tooth tips 26 so as to form bearing surfaces 28 located to the left and right of a tooth tip degree.

FIG. 2 shows the stator 10, which is joined in a force-fitting/frictional manner from the stator star 2 and a stator yoke 30 owing to a compression process, wherein, in addition, a cohesive connection between the stator star 2 and the stator yoke 30 is produced by a heat-activatable adhesive 36 deposited on an inner and an outer lateral surface 32, 34. The adhesive 36 is mixed with a reactive diluent, with the result that the adhesive has a comparatively low viscosity. The adhesive 36 is deposited after the joining process of the stator star 2 and the stator yoke 30, wherein the adhesive 36 is drawn into the formed laminate stack of the stator 10 by means of capillary effects owing to the low viscosity.

The cohesive connections are in particular produced by the adhesive 36, which is applied after the joining process and is drawn in by capillary action, between the tooth tips 26 and the connection points 38 corresponding thereto on the inner circumference of the stator yoke 30. After the application of the adhesive 36, the stator 10 is preferably spun or rotated, with the result that in particular the adhesive 36 on the inner lateral surface 32 is guided at least partially in the direction of the outer lateral surface or towards the outer circumference 34, in particular towards the connection points 38, by means of the generation of centrifugal and inertial forces owing to a centrifugal force. FIG. 2 illustrates the outer lateral surface 34 merely by way of example with an adhesive layer 36.

In order to advantageously influence the capillary flow properties of the adhesive 36, the adhesive 36 and the stator 10 are heated to approximately 30° C. to 50° C. during the adhesive deposition, wherein the stator 10 is preferably approximately 5° C. to 10° C. warmer than the adhesive 36. After the application of the adhesive 36, the stator 10 is spun, and then it is heated in a heat chamber at approximately 160° C. for an hour, with the result that the adhesive 36 cures, and thereby a particularly rigid and stable stator assembly 10 is formed.

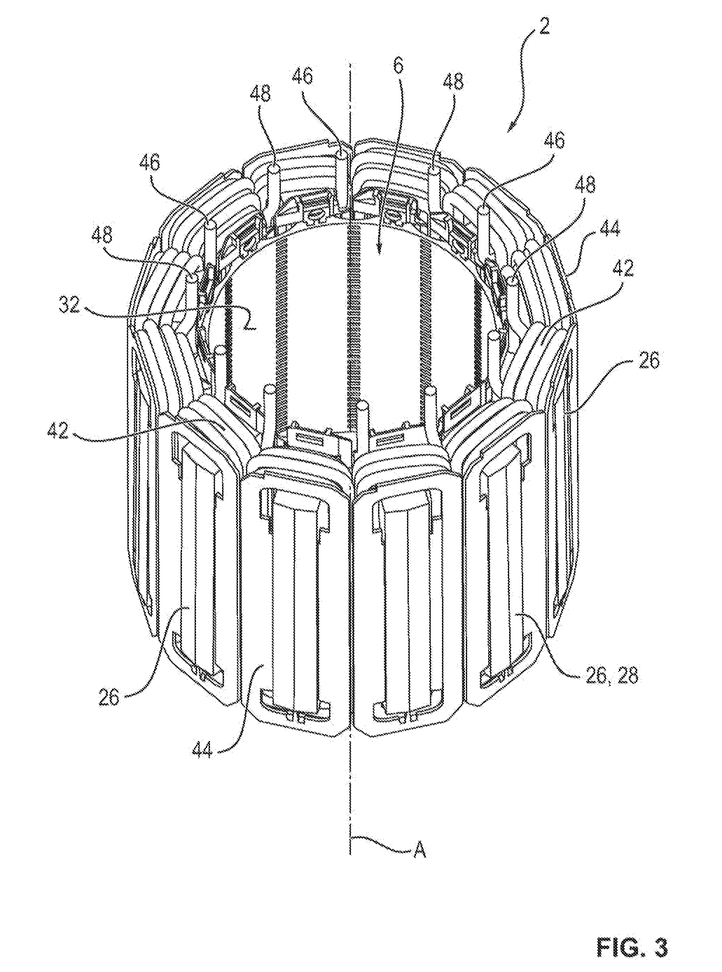

The stator yoke 30 is manufactured from magnetic return path ring laminations or stator laminations 40 stacked one on top of the other. In the fitted state, the windings (not shown in FIG. 2) are positioned around the stator teeth 18 of the stator star 2. The windings are positioned, as coils 42, on winding mounts 44 and positioned with these on the stator teeth 18, prior to the joining of the stator star 2 and the stator yoke 30, as shown in FIG. 3. Each of the frame-like winding mounts 44 bears a coil or coil winding 42 as part of the stator winding. In each case two successive coils 42 are continuously connected and form a coil pair with the coils 42, connected in series. The coil pairs can each be contact-connected via two coil ends 46, 48.

The in total twelve coil ends 46, 48 illustrated in FIG. 3 are oriented axially, i.e. in the axial direction A (direction of the motor axis), for further contact-making by an interconnection element 50 shown in FIG. 4. During electric-motor operation, the energized windings produce the stator-side magnetic field, which enters into interaction with permanent magnets of the rotor 22, rotating about the central stator or motor axis A, of the brushless electric motor 12. The ring-shaped interconnection element 50 serves the purpose of contact-connecting and interconnecting the coil ends 46, 48 such that they are delta-connected.

The invention is not restricted to the above-described exemplary embodiments. Instead, other variants of the invention can also be derived herefrom by a person skilled in the art without departing from the subject matter of the invention. In particular, additionally all of the individual features described in connection with the exemplary embodiments can also be combined with one another in a different way without departing from the subject matter of the invention.

The following is a summary list of reference numerals and the corresponding structure used in the above description of the invention:
2 stator star
4 stator lamination
6 opening
8 stacking direction
10 stator
12 electric motor
14 upper side
16 lower side
18 stator tooth
20 pole shoe
22 rotor
24 gap
26 tooth tip
28 bearing surface
30 stator yoke
32 lateral surface/inner circumference
34 lateral surface/outer circumference
36 adhesive
38 connection point
40 stator lamination
42 coil/coil winding
44 winding mount
46 coil end
48 coil end
50 interconnection element
A axial direction

1. A stator for an electric motor, the stator comprising:
a cylindrical stator yoke having connection points including stator yoke-side connection points;
a stator star joined to said stator yoke and having a plurality of stator teeth being directed radially outwards, said stator teeth having tooth tips bearing against corresponding ones of said connection points on an inner circumference of said cylindrical stator yoke in a joined state, said tooth tips including stator star-side tooth tips;
said cylindrical stator yoke and said stator star each being formed by a punch-stacked laminate stack; and
an adhesive being drawn in by capillary action is introduced between said stator star-side tooth tips and said stator yoke-side connection points for producing a cohesive connection.

2. The stator according to claim 1, wherein said tooth tips of said stator teeth are formed with joining contours, and said connection points on said inner circumference of said cylindrical stator yoke are formed with mirror-inverted joining contours.

3. The stator according to claim 1, wherein said adhesive is a two-component bonding agent, to which a reactive diluent has been added for reducing an adhesive viscosity.

4. The stator according to claim 2, wherein:
said joining contours are wedge shaped; and
said mirror-inverted joining contours are wedge shaped.

5. A method for producing a stator, which comprises the steps of:
providing a cylindrical stator yoke;
providing a stator star having a plurality of outwardly directed stator teeth;
placing in each case one coil of a stator winding onto the stator teeth;
performing a joining process where the stator star provided with the coils and the cylindrical stator yoke are joined to one another so as to form connection points between tooth tips of the stator teeth and the cylindrical stator yoke; and
subsequently, after the joining process, applying a low-viscosity adhesive to a lateral surface of the stator.

6. The method according to claim 5, which further comprises applying the low-viscosity adhesive in a region of the connection points of the cylindrical stator yoke.

7. The method according to claim 5, which further comprises introducing the low-viscosity adhesive into an inner circumference of the stator and is guided at least partially towards an outer circumference by means of a generation of a centrifugal force.

8. The method according to claim 5, wherein the low-viscosity adhesive is a heat-activatable adhesive and the stator is delivered to a heat chamber for curing of the heat-activatable adhesive.

9. The method according to claim 8, which further comprises heating the heat-activatable adhesive and/or the stator during the applying step.

10. The method according to claim 9, which further comprises heating the stator to a higher temperature than the heat-activatable adhesive.

11. An electric motor, comprising:
a stator, containing:
a cylindrical stator yoke having connection points including stator yoke-side connection points;
a stator star joined to said stator yoke and having a plurality of stator teeth being directed radially outwards, said stator teeth having tooth tips bearing against corresponding ones of said connection points on an inner circumference of the cylindrical stator yoke in a joined state, said tooth tips including stator star-side tooth tips;
said cylindrical stator yoke and said stator star each being formed by a punch-stacked laminate stack; and
an adhesive being drawn in by capillary action is introduced between said stator star-side tooth tips and said stator yoke-side connection points for producing a cohesive connection.

12. The electric motor according to claim 11, wherein the electric motor is a steering motor of a motor vehicle.
